(19) United States
(12) Patent Application Publication
(10) Pub. No.: US 2026/0138144 A1
(43) Pub. Date: May 21, 2026

(54) SPRAY FOAM DUAL APPLICATOR PROPORTIONER

(71) Applicant: Polyurethane Machinery Corporation, Lakewood, NJ (US)

(72) Inventors: Bryan Minue, Toms River, NJ (US); Kuan-Yu Chen, Little Silver, NJ (US); Dan Holm, Hazlet, NJ (US); Pete Sibole, Toms River, NJ (US); Peter Tarabocchia, Bayville, NJ (US); Matt DeJesus, Howell, NJ (US)

(21) Appl. No.: 19/389,396

(22) Filed: Nov. 14, 2025

Related U.S. Application Data
(60) Provisional application No. 63/721,735, filed on Nov. 18, 2024.

(51) Int. Cl. B05B 12/00; B05B 7/00; B05B 12/10; B05B 12/14; B05B 15/40

(52) U.S. Cl. CPC B05B 12/008; B05B 7/0018; B05B 12/10; B05B 12/1418; B05B 15/40

(57) ABSTRACT

A dual-applicator spray foam proportioner system featuring a manifold that divides A-material and B-material into parallel branches for two independently operable applicators. Each branch is equipped with dedicated flowmeters, temperature sensors, and pressure sensors, all monitored by a controller. The controller continuously compares measurements to predetermined temperature, pressure, and accumulated flow ratio conditions, ceasing pump operation if any parameter falls outside its range to prevent undesirable mixtures. The system includes a dual-output hose heat transformer for independent temperature control of each applicator. This architecture enables simultaneous, high-quality spray foam application from two applicators, with enhanced safety, reliability, and mix consistency.

### CROSS-REFERENCE TO RELATED APPLICATION

This application claims priority to U.S. Provisional Patent Application No. 63/721,735, filed Nov. 18, 2024, the disclosure of which is hereby incorporated by reference herein in its entirety.

### TECHNICAL FIELD

The present invention relates generally to a spray applicator, more particularly, to a spray foam and method of applying spray foam.

### BACKGROUND

Spray foam insulation systems are widely used in residential, commercial, and industrial applications due to their superior thermal performance, air sealing capabilities, and structural reinforcement properties. These systems typically rely on the mixing and application of two reactive chemical components, commonly referred to as A-material (e.g., isocyanate) and B-material (e.g., polyol). The A-material and the B-material are combined at the point of application to form a rigid or semi-rigid foam.

Conventional spray foam proportioners are generally configured to support a single applicator, limiting the efficiency and throughput of foam application, particularly in large-scale projects or environments requiring simultaneous operation by multiple technicians. In such cases, users must either alternate use of the applicator or deploy multiple proportioners, which increases equipment costs, setup complexity, and maintenance burdens.

Moreover, existing systems often lack integrated quality control mechanisms capable of monitoring real-time material conditions such as temperature, pressure, and flowrate, and automatically inhibiting operation when these conditions fall outside acceptable ranges. This can result in improper mixing ratios, substandard foam quality, and material waste, especially when environmental or operational variables fluctuate during use.

There remains a need in the art for a spray foam proportioner system that enables simultaneous operation of multiple applicators while maintaining independent control and monitoring of material conditions for each applicator. Additionally, there is a need for a system that incorporates automated quality control functionality to prevent undesirable mixtures and ensure consistent foam performance.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a front elevational view of a spray foam dual applicator proportioner system including a dual proportioner and a dual applicator arrangement;

FIG. 2 depicts a side elevational view of the dual proportioner of FIG. 1; and

FIG. 3 depicts a quality control method for the spray foam dual applicator proportioner system of FIG. 1.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

For clarity of disclosure, to the extent that such terms may be used herein, the terms “vertical,” “horizontal,” and “radial” are defined herein relative to a circular storage tank positioned on a ground surface. In this respect, “lower vertical direction” is toward to the ground, “upper vertical direction” is away from the ground, “left horizontal direction” is circumferentially left parallel to the ground, “right horizontal direction” is circumferentially right parallel to the ground, and “radial direction” is toward or away from an outer wall of the storage tank relative to a central axis of the storage tank. It will be further appreciated that, for convenience and clarity, spatial terms such as “upper,” “lower,” “lateral,” “inner,” “outer,” “leftward,” “rightward,” and “central” also are used herein for reference to relative positions and directions. Such terms may be used below with reference to views as illustrated for clarity and are not intended to limit the invention described herein.

### I. Example of a Spray Foam Dual Applicator

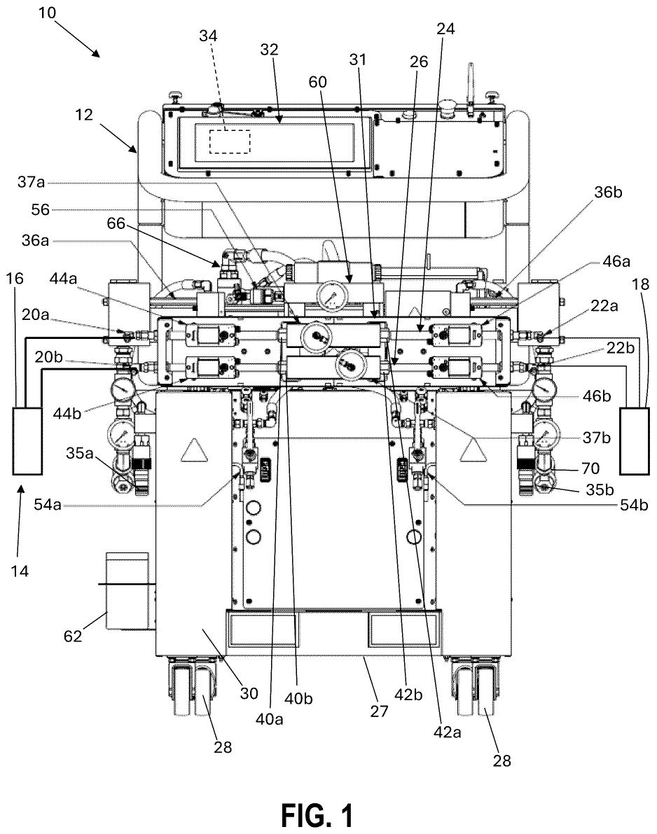

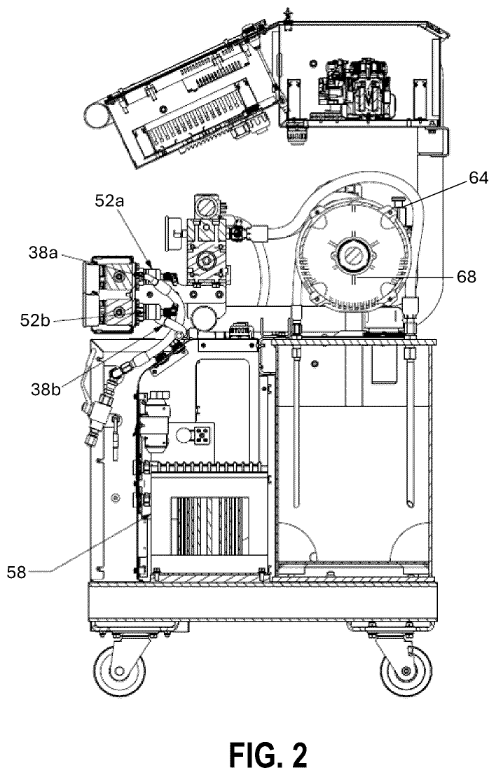

FIGS. 1 through 2 show an example of a spray foam dual applicator proportioner system (10) including a dual proportioner (12) and a dual applicator arrangement (14) with a first applicator (16) and a second applicator (18) configured to respectively connect to a first pair of outlets (20a, 20b) and a second pair of outlets (22a, 22b) such that first and second applicators (16, 18) are independently operable during use. While the present disclosure refers to “foam” or “spray foam,” which typically operates at low pressure (around 2000 psi), dual applicator proportioner system (10) may also be used for high-pressure applications (around 3000 psi), such as polyurea coatings or bedliners. Thus the description of system (10) herein is for exemplary purposes only and no form-specific limitations should be implied. In this respect, dual proportioner (12) is configured to deliver a pressurized A-material and a pressurized B-material to first pair of outlets (20a, 20b) and second pair of outlets (22a, 22b) at predetermined pressures and temperatures for mixing and application via first and second applicators (16, 18). In some versions of spray foam dual applicator proportioner system (10), the predetermined conditions such as pressure and temperature are user-defined and may be entered into system (10) via any common method for providing data, such as by way of an interface (not shown). In the present example, A-material includes isocyanate, B-material includes polyol, and applicators (16, 18) are spray guns configured for spraying a mixture of isocyanate and polyol for applying an insulation product, which may also be referred to herein as spray foam. The terms “A-material” and “B-material” are not intended to be unnecessarily limited to isocyanate and polyol and may be any useful for identifying differing materials. Similarly, the following references to “A-side” portions of dual proportioner (12) as distinct from “B-side” portions of dual proportioner (12) identify features of one flow circuit for A-material and another flow circuit for B-material through dual proportioner (12). For convenience, flow circuit for A-material will be referred to herein as a “flow circuit A,” whereas flow circuit for B-material will be referred to herein as “flow circuit B.”

To this end, dual proportioner (12) includes a flow circuit A (24), a flow circuit B (26), which is fluidly isolated from, such as not fluidly connected to, flow circuit A (24), a frame (27) supported by a plurality of castor wheels (28), and a housing (30) attached to frame (27). A material manifold (31) is further incorporated into dual proportioner (12) for directing A-material and B-material respectively through flow circuit A (24) and flow circuit B (26). Housing (30), which includes a plurality of panels, is attached to frame (27) to cover various portions of dual proportioner (12) to define various compartments and/or inhibit access as desired. In addition, dual proportioner (12) includes a control panel (32) with a controller (34) configured direct operation of one or more portions of dual proportioner (12) as discussed below in greater detail. Controller (34) includes a microprocessor and a memory for storage of information as will be appreciated by one of ordinary skill in the art unless otherwise noted below.

Flow circuit A (24) of the present example includes a supply inlet (35a) configured to fluidly connect to a storage supply of A-material for receiving the A-material therefrom. Flow circuit A (24) further includes an A-side metering pump (36a) that receives A-material from supply inlet (35a) for pumping A-material toward an A-side manifold (37a) of material manifold (31). To this end, A-side manifold (37a) has an A-side manifold inlet (38a) that receive the A-material from A-side metering pump (36a) and distributes the flow of A-material to a first A-side manifold outlet (40a) and a second A-side manifold outlet (42a). Respective flows of A-material discharged from first and second A-side manifold outlets (40a, 42a) then pass through a first A-side flowmeter (44a) and a second A-side flowmeter (46a), respectively. In the present example, flow circuit A (24) terminates at first A-side outlet (20a) and a second A-side outlet (22a) for fluidly connecting to first and second applicators (16, 18) as discussed below. Each of the features of flow circuit A (24) are fluidly connected by conduits, such as hoses and/or pipes, in the present example, although the invention is not intended to be unnecessarily limited to any particular form of fluid connection.

Notably, in addition to first and second A-side flowmeters (44a, 46a) configured to measure flows of A-material therethrough, flow circuit A (24) further includes additional sensors for measuring states of A-material in real-time. To this end, the present example of flow circuit A (24) includes an A-side pressure transducer (52a) and an A-side outlet temperature sensor (54a). A-side pressure transducer (52a) is mounted to A-side manifold (37a) and configured to measure a pressure of A-material within A-side manifold (37a), such as at A-side manifold inlet (38a). A-side outlet temperature sensor (54a) is operatively connected to first and second A-side outlets (20a, 22a) and configured to measure a temperature of A-material therein. Each of first and second A-side flowmeters (44a, 46a), A-side pressure transducer (52a), and A-side outlet temperature sensor (54a) are operatively connected to controller (34) such that controller (34) monitors measurements of same to direct operation of dual proportioner (12) as discussed below in greater detail.

Turning to flow circuit B (26), flow circuit B (26) of the present example includes a supply inlet (35b) configured to fluidly connect to a storage supply of B-material for receiving the B-material therefrom. Flow circuit B (26) further includes a B-side metering pump (36b) that receives B-material from supply inlet (35b) for pumping B-material toward a B-side manifold (37b) of material manifold (31). To this end, B-side manifold (37b) has a B-side manifold inlet (38b) that receive the B-material from B-side metering pump (36b) and distributes the flow of B-material to a first B-side manifold outlet (40b) and a second B-side manifold outlet (42b). Respective flows of B-material discharged from first and second B-side manifold outlets (40b, 42b) then pass through a first B-side flowmeter (44b) and a second B-side flowmeter (46b), respectively. In the present example, flow circuit B (26) terminates at a first B-side outlet (20b) and a second B-side outlet (22b) for fluidly connecting to first and second applicators (16, 18) as discussed below. Each of the features of flow circuit B (26) are fluidly connected by conduits, such as hoses and/or pipes, in the present example, although the invention is not intended to be unnecessarily limited to any particular form of fluid connection.

Notably, in addition to first and second B-side flowmeters (44b, 46b) configured to measure flows of B-material therethrough, flow circuit B (26) further includes additional sensors for measuring states of B-material in real-time. To this end, the present example of flow circuit B (26) includes a B-side pressure transducer (52b) and a B-side outlet temperature sensor (54b). B-side pressure transducer (52b) is mounted to B-side manifold (37b) and configured to measure a pressure of B-material within B-side manifold (37b), such as at B-side manifold inlet (38b). B-side outlet temperature sensor (54b) is operatively connected to first and second B-side outlets (20b, 22b) and configured to measure a temperature of B-material therein. Each of first and second B-side flowmeters (44b, 46b), B-side pressure transducer (52b), and B-side outlet temperature sensor (54b) are operatively connected to controller (34) such that controller (34) monitors measurements of same to direct operation of dual proportioner (12) as discussed below in greater detail.

Flow circuit A (24) and flow circuit B (26) are secured relative to frame (27) to enable and aid in connected first and second applicators (16, 18) for use. In particular, first A-side outlet (20a) is positioned proximate to first B-side outlet (20b) on one lateral side portion of frame (27) and thereby configured to be connected to first applicator (16). In contrast, second A-side outlet (22a) is positioned proximate to second B-side outlet (22b) on an opposing lateral side portion of frame (27) and thereby configured to be connected to second applicator (18). First A-side outlet (20a) and first B-side outlet (20b) therefore discharge A-material and B-material proximate to each other for mixing in first applicator (16) and spraying the spray foam while, simultaneously, second A-side outlet (22a) and second B-side outlet (22b) discharge A-material and B-material proximate to each other for mixing in second applicator (18) and spraying the spray foam. While dual proportioner (12) is configured to perform simultaneous operation of first and second applicators (16, 18), dual proportioner (12) may be operated in a manner such that only one of first or second applicator (16, 18) is being used at any given time. In this respect, dual proportioner (12) is capable of single or dual use of first and second applicators (16, 18) and not intended to be only used simultaneously.

In addition to the above features, in one example, dual proportioner (12) further includes a hydraulic pressure transducer (56), a dual-output hose heat transformer (58) with multiple tap settings per output, a hydraulic cylinder manifold (60) for powering A-side and B-side metering pumps (36a, 36b), a lube reservoir (62) for providing lubricant to A-side metering pump (36a) to inhibit crystallization accumulation, a hydraulic pressure control (64) for adjusting pressure of hydraulics within hydraulic system, a hydraulic manifold assembly (66) to provide pressure measurements of hydraulic fluid and flow direction of same, a motor (68) to power hydraulic pump, and one or more strainers (70) for filtering debris from the flow of materials. For example, strainer (70) may be disposed upstream from one of the outlets (20a, 20b, 22a, 22b) for filtering debris from the flow of materials prior to passing through that outlet (20a, 20b, 22a, 22b). Notably, in one example, dual-output hose heat transformer (58) provides independent power and controls for powering first and second applicators (16, 18) thereby enabling independent temperature control of heating elements associated with respective first and second applicators (16, 18) during use. Also, in one example, first and second A-side flowmeters (44a, 46a) as well as first and second B-side flowmeters (44b, 46b) are ultrasonic flowmeters, but dual proportioner (12) is not intended to be unnecessarily limited to use with ultrasonic flowmeters.

### II. Example of Quality Control Method for Spray Foam Dual Applicator Proportioner System

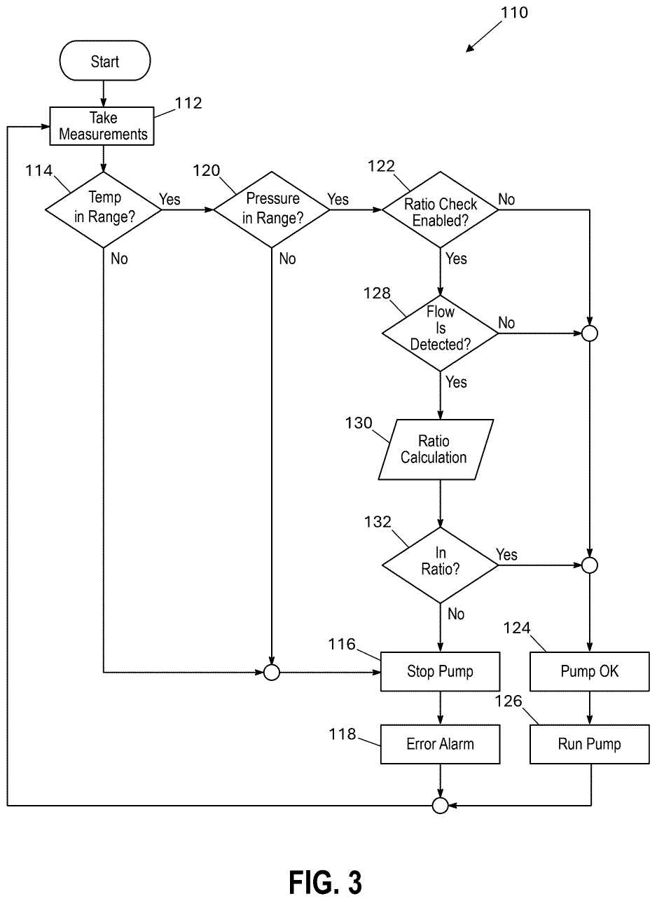

With reference back to FIGS. 1-2, FIG. 3 shows one example of a quality control method (110) performed by controller (34) for inhibiting operation of spray foam dual applicator proportioner system (10) unless real-time conditions of A-material and B-material are appropriate for applying spray foam as desired. More particularly, controller (34) monitors, in real-time, first and second A-side flowmeters (44a, 46a), A-side pressure transducer (52a), and A-side outlet temperature sensor (54a) of flow circuit A (24) while also monitoring, in real-time, first and second B-side flowmeters (44b, 46b), B-side pressure transducer (52b), and B-side outlet temperature sensor (54b). In turn, controller (34) collects a plurality of material measurements, including a first A-side material flowrate measurement, a second A-side material flowrate measurement, a first B-side material flowrate measurement, a second B-side material flowrate measurement, an A-side material pressure measurement, a B-side material pressure measurement, an A-side material temperature measurement, and a B-side material temperature measurement. These material measurements are then compared to a plurality of predetermined (potentially user-defined) conditions stored on the memory of controller (34) such that spray foam dual applicator proportioner system (10) is operational unless any one or more of the plurality of material measurements are outside of the predetermined conditions as discussed below at which time controller (34) ceases operation of each spray foam dual applicator proportioner system (10). Thereby, controller (34) terminates application of spray foam with first and second applicators (16, 18) to prevent spraying material mixtures that may be defective in some aspect. In the present example, the plurality of predetermined conditions stored on the memory of controller (34) includes a predetermined temperature range, a predetermined pressure range, and a predetermined flow ratio range for comparison to the measurements discussed above. However, it will be appreciated that more or less measurements and/or predetermined conditions may be used in another example such that the invention is not intended to be unnecessarily limited to the particular measurements and predetermined conditions discussed in the present example. In some versions of the disclosure, the predetermined conditions are user-defined and entered into the controller via any common input method such as an interface (not shown).

In one example, quality control method (110) initially takes measurements in a step (112). For example, quality control method (110) measures a first A-side material flowrate measurement, a second A-side material flowrate measurement, a first B-side material flowrate measurement, a second B-side material flowrate measurement, an A-side material pressure measurement, a B-side material pressure measurement, an A-side material temperature measurement, and a B-side material temperature measurement in step (112) and thereafter moves to a step (114). In step (114), controller (34) compares each of the A-side material temperature measurement and the B-side material temperature measurement to the predetermined temperature range as applicable for the materials in step (114). In the event that any one or more of the A-side material temperature measurement and the B-side material temperature measurement are outside of the predetermined temperature range, then controller (34) stops pumping all material, such as by stopping A-side and B-side metering pumps (36a, 36b), in a step (116) followed by an error alarm in a step (118) to notify a user of an error.

In contrast, if each of the A-side material temperature measurement and the B-side material temperature measurement are within the predetermined temperature range, then step (114) moves to a step (120), whereby controller (34) compares the A-side material pressure measurement and the a B-side material pressure measurement to the predetermined pressure range as applicable for the materials. In the event that any one or more of the A-side material pressure measurement and the B-side material pressure measurement are outside of the predetermined pressure range, then controller (34) stops pumping all material, such as by stopping A-side and B-side metering pumps (36a, 36b), in step (116) followed by the error alarm in step (118) to notify a user of an error.

Also in the present example, quality control method (110) further includes a flowrate check that may or may not be enabled in a step (122). If not enabled, then controller determines, based on affirmative feedback of temperature and pressure comparisons discussed above, that pumping remains acceptable in a step (124), continues to run applicable pumps in a step (126), and then returns to the measurements step (112) to continue monitoring conditions of the A-material and the B-material.

In the event that the flowrate check is enabled in step (122), controller (34) then, in communication with first and second A-side flowmeters (44a, 46a) and first and second B-side flowmeters (44b, 46b), determines whether or not flow is occurring through each of first and second A-side flowmeters (44a, 46a) and first and second B-side flowmeters (44b, 46b) in a step (128). In the event that no flow is detected in any one flowmeter (44a, 44b, 46a, 46b), then controller (34) simply move forward with steps (124, 126) for that respective flowmeter (44a, 44b, 46a, 46b). For any one of flowmeters (44a, 44b, 46a, 46b) that does have a flow occurring therethrough, controller (34) determines the flowrate through each of the applicable flowmeters (44a, 44b, 46a, 46b) in a step (130). Thereafter, in a step (132), controller (34) calculates an accumulated flow ratio based on each determined flowrate and then compares this accumulated flow ratio to the predetermined flow ratio range to further determine whether or not the accumulated flow ratio is within the predetermined flow ratio range. In the event that the accumulated flow ratio is within the predetermined flow ratio range, then controller moves forward with steps (124, 126) as discussed above. However, in the event that the accumulated flow ratio is outside the predetermined flow ratio range, then controller moves forward to stop pumping all material, such as by stopping A-side and B-side metering pumps (36a, 36b), in step (116) followed by the error alarm in step (118) to notify a user of an error. Controller (34) thus continues performing quality control method (110) to verify that conditions of A-material and B-material are appropriate for applying spray foam as desired.

### III. EXAMPLES

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A device, comprising: (a) a manifold, including: (i) an A-side manifold inlet configured to receive an A-material therefrom, (ii) a B-side manifold inlet configured to receive a B-material therefrom, (iii) a first A-side manifold outlet and a second A-side manifold outlet, wherein each of the first and second A-side manifold outlets are fluidly connected to the A-side manifold inlet, and wherein the manifold is configured to divide flowing A-material from the A-side manifold inlet to each of the first and second A-side manifold outlets, and (iv) a first B-side manifold outlet and a second B-side manifold outlet, wherein each of the first and second B-side manifold outlets are fluidly connected to the B-side manifold inlet, and wherein the manifold is configured to divide flowing B-material from the B-side manifold inlet to each of the first and second B-side manifold outlets, (b) a first A-side circuit outlet configured to connect to a first applicator; (c) a second A-side circuit outlet configured to connect to a second applicator; (d) a first B-side circuit outlet configured to connect to the first applicator; (e) a second B-side circuit outlet configured to connect to the second applicator; (f) a plurality of sensors monitoring a plurality of A-material conditions and a plurality of B-material conditions; (g) at least one A-side pump configured to direct A-material through the manifold and toward each of the first and second A-side circuit outlets, (h) at least one B-side pump configured to direct B-material through the manifold and toward each of the first and second B-side circuit outlets; and (i) a controller operatively connected to the plurality of sensors and having at least one predetermined condition stored thereon, wherein the controller is configured to: (i) compare at least one measurement from the plurality of sensors to the at least one predetermined condition stored thereon, and (ii) cease operation of the at least one A-side pump and the at least one B-side pump based on the comparison of the at least one measurement from the plurality of sensors to the at least one predetermined condition stored thereon.

### Example 2

The device, system, or method of any of the previous or subsequent Examples, wherein the plurality of sensors includes: (i) at least one A-side temperature sensor configured to measure at least one A-side material temperature, (ii) at least one B-side temperature sensor configured to measure at least one B-side material temperature, (iii) at least one A-side pressure sensor configured to measure at least one A-side material pressure, and (iv) at least one B-side pressure sensor configured to measure at least one B-side material pressure.

### Example 3

The device, system, or method of any of the previous or subsequent Examples, wherein the plurality of sensors includes: (i) a first A-side flowmeter fluidly connected between the first A-side manifold outlet and the first A-side circuit outlet, wherein the first A-side flowmeter is configured to measure a first A-side material flowrate received from the first A-side manifold outlet and passing therethrough, (ii) a second A-side flowmeter fluidly connected between the second A-side manifold outlet and the second A-side circuit outlet, wherein the second A-side flowmeter is configured to measure a second A-side material flowrate received from the second A-side manifold outlet and passing therethrough, (iii) a first B-side flowmeter fluidly connected between the first B-side manifold outlet and the first B-side circuit outlet, wherein the first B-side flowmeter is configured to measure a first B-side material flowrate received from the first B-side manifold outlet and passing therethrough, and (iv) a second B-side flowmeter fluidly connected between the second B-side manifold outlet and the second B-side circuit outlet, wherein the second B-side flowmeter is configured to measure a second B-side material flowrate received from the second B-side manifold outlet and passing therethrough.

### Example 4

The device, system, or method of any of the previous or subsequent Examples, further comprising a hose heat transformer having a first hose output configured to connect to the first applicator and a second hose output configured to connect to the second applicator, wherein the hose heat transformer is configured to control heat output to the first applicator via the first hose output, wherein the hose heat transformer is configured to control heat output to the second applicator via the second hose output.

### Example 5

The device, system, or method of any of the previous or subsequent Examples, wherein the hose heat transformer is configured to control heat output to the first applicator independently from heat output to the second applicator.

### Example 6

The device, system, or method of any of the previous or subsequent Examples, further comprising a first applicator and a second applicator.

### Example 7

A method of inhibiting an undesirable mixture of an A-material and a B-material with a proportioner, comprising: (a) comparing at least one measurement from a plurality of sensors to the at least one predetermined condition stored thereon, and (b) ceasing operation of an A-side pump and a B-side pump based on the comparison of the at least one measurement from the plurality of sensors to the at least one predetermined condition stored thereon thereby inhibiting the undesirable mixture of the A-material and the B-material.

### Example 8

The device, system, or method of any of the previous or subsequent Examples, further comprising applying spray foam from at least one of a first applicator and a second applicator, wherein at least one of the first and second applicators are connected to the proportioner.

### Example 9

The device, system, or method of any of the previous or subsequent Examples, further comprising applying spray foam from each of a first applicator and a second applicator, wherein each of the first and second applicators are connected to the proportioner.

### Example 10

The device, system, or method of any of the previous or subsequent Examples, further comprising independently regulating heat output to the first applicator and the second applicator via a dual-output hose heat transformer, based on temperature measurements from at least one A-side temperature sensor and at least one B-side temperature sensor.

### Example 11

The device, system, or method of any of the previous or subsequent Examples, wherein the at least one predetermined condition is defined by a user.

### Example 12

The device, system, or method of any of the previous or subsequent Examples, wherein comparing at least one measurement comprises comparing an accumulated flow ratio, calculated from flowrates measured by a first A-side flowmeter, a second A-side flowmeter, a first B-side flowmeter, and a second B-side flowmeter, to a predetermined flow ratio range stored on the controller.

### Example 13

The device, system, or method of any of the previous or subsequent Examples, further comprising ceasing operation of the A side pump and the B side pump and issuing an error alarm when the accumulated flow ratio is outside the predetermined flow ratio range.

### Example 14

A spray foam proportioner system comprising: (a) a manifold having an A-side manifold inlet for receiving A-material therein and a B-side manifold inlet for receiving B-material therein, the manifold configured to divide A-material into a first A-side outlet and a second A-side outlet, and divide B-material into a first B-side outlet and a second B-side outlet; (b) a first applicator fluidly connected to the first A-side outlet and the first B-side outlet, and a second applicator fluidly connected to the second A-side outlet and the second B-side outlet; (c) a plurality of sensors including: (i) a first A-side flowmeter positioned between the first A-side outlet and the first applicator; (ii) a second A-side flowmeter positioned between the second A-side outlet and the second applicator; (iii) a first B-side flowmeter positioned between the first B-side outlet and the first applicator; (iv) a second B-side flowmeter positioned between the second B-side outlet and the second applicator; (v) at least one A-side temperature sensor, at least one B-side temperature sensor, at least one A-side pressure sensor, and at least one B-side pressure sensor; (d) a plurality of pumps including: (i) at least one A-side pump configured to deliver A-material through the manifold, and (ii) at least one B-side pump configured to deliver B-material through the manifold; (e) a controller operatively connected to the plurality of sensors and the plurality of pumps, the controller configured to: (i) continuously compare measurements from the plurality of sensors to at least one predetermined condition stored thereon, including a temperature range, a pressure range, and an accumulated flow ratio range calculated from the flowmeters; and (ii) cease operation of the A-side pump and the B-side pump when any measurement falls outside the predetermined condition.

### Example 15

The device, system, or method of any of the previous or subsequent Examples, wherein the controller is configured to issue an error alarm upon ceasing operation of a pump.

### Example 16

The device, system, or method of any of the previous or subsequent Examples, wherein the controller is configured to independently regulate heat output to the first applicator and the second applicator via a dual-output hose heat transformer.

### Example 17

The device, system, or method of any of the previous or subsequent Examples, wherein the dual-output hose heat transformer is configured to independently maintain a selected temperature setpoint for each applicator based on real-time temperature measurements.

### Example 18

The device, system, or method of any of the previous or subsequent Examples, further comprising a lube reservoir for providing lubricant to one or both of the A-side pump and B-side pump to inhibit crystallization accumulation.

### Example 19

The device, system, or method of any of the previous Examples, further comprising a strainer disposed upstream from the first B-side outlet for filtering debris from the flow of materials prior to passing through the first B-side outlet.

### IV. Miscellaneous

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A device, comprising:
(a) a manifold, including:
(i) an A-side manifold inlet configured to receive an A-material therefrom,
(ii) a B-side manifold inlet configured to receive a B-material therefrom,
(iii) a first A-side manifold outlet and a second A-side manifold outlet, wherein each of the first and second A-side manifold outlets are fluidly connected to the A-side manifold inlet, and wherein the manifold is configured to divide flowing A-material from the A-side manifold inlet to each of the first and second A-side manifold outlets, and
(iv) a first B-side manifold outlet and a second B-side manifold outlet, wherein each of the first and second B-side manifold outlets are fluidly connected to the B-side manifold inlet, and wherein the manifold is configured to divide flowing B-material from the B-side manifold inlet to each of the first and second B-side manifold outlets,
(b) a first A-side circuit outlet configured to connect to a first applicator;
(c) a second A-side circuit outlet configured to connect to a second applicator;
(d) a first B-side circuit outlet configured to connect to the first applicator;
(e) a second B-side circuit outlet configured to connect to the second applicator;
(f) a plurality of sensors monitoring a plurality of A-material conditions and a plurality of B-material conditions;
(g) at least one A-side pump configured to direct A-material through the manifold and toward each of the first and second A-side circuit outlets;
(h) at least one B-side pump configured to direct B-material through the manifold and toward each of the first and second B-side circuit outlets; and
(i) a controller operatively connected to the plurality of sensors and having at least one predetermined condition stored thereon, wherein the controller is configured to:
(i) compare at least one measurement from the plurality of sensors to the at least one predetermined condition stored thereon, and
(ii) cease operation of the at least one A-side pump and the at least one B-side pump based on comparing the at least one measurement from the plurality of sensors to the at least one predetermined condition stored thereon.

2. The device of claim 1, wherein the plurality of sensors includes:
(i) at least one A-side temperature sensor configured to measure at least one A-side material temperature,
(ii) at least one B-side temperature sensor configured to measure at least one B-side material temperature,
(iii) at least one A-side pressure sensor configured to measure at least one A-side material pressure, and
(iv) at least one B-side pressure sensor configured to measure at least one B-side material pressure.

3. The device of claim 1, wherein the plurality of sensors includes:
(i) a first A-side flowmeter fluidly connected between the first A-side manifold outlet and the first A-side circuit outlet, wherein the first A-side flowmeter is configured to measure a first A-side material flowrate received from the first A-side manifold outlet and passing therethrough,
(ii) a second A-side flowmeter fluidly connected between the second A-side manifold outlet and the second A-side circuit outlet, wherein the second A-side flowmeter is configured to measure a second A-side material flowrate received from the second A-side manifold outlet and passing therethrough,
(iii) a first B-side flowmeter fluidly connected between the first B-side manifold outlet and the first B-side circuit outlet, wherein the first B-side flowmeter is configured to measure a first B-side material flowrate received from the first B-side manifold outlet and passing therethrough, and
(iv) a second B-side flowmeter fluidly connected between the second B-side manifold outlet and the second B-side circuit outlet, wherein the second B-side flowmeter is configured to measure a second B-side material flowrate received from the second B-side manifold outlet and passing therethrough.

4. The device of claim 3, wherein the plurality of sensors further includes:
(i) at least one A-side temperature sensor configured to measure at least one A-side material temperature,
(ii) at least one B-side temperature sensor configured to measure at least one B-side material temperature,
(iii) at least one A-side pressure sensor configured to measure at least one A-side material pressure, and
(iv) at least one B-side pressure sensor configured to measure at least one B-side material pressure.

5. The device of claim 1, further comprising a hose heat transformer having a first hose output configured to connect to the first applicator and a second hose output configured to connect to the second applicator, wherein the hose heat transformer is configured to control heat output to the first applicator via the first hose output, wherein the hose heat transformer is configured to control heat output to the second applicator via the second hose output.

6. The device of claim 5, wherein the hose heat transformer is configured to control heat output to the first applicator independently from heat output to the second applicator.

7. The device of claim 1, further comprising a first applicator and a second applicator.

8. A method of inhibiting an undesirable mixture of an A-material and a B-material with a proportioner, comprising:
(a) comparing, via a controller, at least one measurement from a plurality of sensors to at least one predetermined condition stored thereon, and
(b) ceasing operation of an A-side pump and a B-side pump based on comparing the at least one measurement from the plurality of sensors to the at least one predetermined condition thereby inhibiting the undesirable mixture of the A-material and the B-material.

9. The method of claim 8, further comprising applying spray foam from at least one of a first applicator and a second applicator, wherein at least one of the first and second applicators are connected to the proportioner.

10. The method of claim 8, further comprising applying spray foam from each of a first applicator and a second applicator, wherein each of the first and second applicators are connected to the proportioner.

11. The method of claim 10, further comprising independently regulating heat output to the first applicator and the second applicator via a dual-output hose heat transformer, based on temperature measurements from at least one A-side temperature sensor and at least one B-side temperature sensor.

12. The method of claim 11, wherein the at least one predetermined condition is defined by a user.

13. The method of claim 8, wherein comparing at least one measurement comprises comparing an accumulated flow ratio, calculated from flowrates measured by a first A-side flowmeter, a second A-side flowmeter, a first B-side flowmeter, and a second B-side flowmeter, to a predetermined flow ratio range stored on the controller.

14. The method of claim 13, further comprising ceasing operation of the A-side pump and the B-side pump and issuing an error alarm when the accumulated flow ratio is outside the predetermined flow ratio range.

15. A spray foam proportioner system comprising:
(a) a manifold having an A-side manifold inlet for receiving A-material therein and a B-side manifold inlet for receiving B-material therein, the manifold configured to divide A-material into a first A-side outlet and a second A-side outlet, and divide B-material into a first B-side outlet and a second B-side outlet;
(b) a first applicator fluidly connected to the first A-side outlet and the first B-side outlet, and a second applicator fluidly connected to the second A-side outlet and the second B-side outlet;
(c) a plurality of sensors including:
(i) a first A-side flowmeter positioned between the first A-side outlet and the first applicator;
(ii) a second A-side flowmeter positioned between the second A-side outlet and the second applicator;
(iii) a first B-side flowmeter positioned between the first B-side outlet and the first applicator;
(iv) a second B-side flowmeter positioned between the second B-side outlet and the second applicator;
(v) at least one A-side temperature sensor, at least one B-side temperature sensor, at least one A-side pressure sensor, and at least one B-side pressure sensor;
(d) a plurality of pumps including:
(i) at least one A-side pump configured to deliver A-material through the manifold, and
(ii) at least one B-side pump configured to deliver B-material through the manifold;
(e) a controller operatively connected to the plurality of sensors and the plurality of pumps, the controller configured to:
(i) continuously compare measurements from the plurality of sensors to at least one predetermined condition stored thereon, including a temperature range, a pressure range, and an accumulated flow ratio range calculated from the flowmeters; and
(ii) cease operation of the A-side pump and the B-side pump when any measurement falls outside the predetermined condition.

16. The system of claim 15, wherein the controller is configured to issue an error alarm upon ceasing operation of a pump.

17. The system of claim 15, wherein the controller is configured to independently regulate heat output to the first applicator and the second applicator via a dual-output hose heat transformer.

18. The system of claim 17, wherein the dual-output hose heat transformer is configured to independently maintain a selected temperature setpoint for each applicator based on real-time temperature measurements.

19. The system of claim 15, further comprising a lube reservoir for providing lubricant to one or both of the A-side pump and B-side pump to inhibit crystallization accumulation.

20. The system of claim 15, further comprising a strainer disposed upstream from the first B-side outlet for filtering debris from the flow of materials prior to passing through the first B-side outlet.
